(19) United States
(12) Patent Application Publication
(10) Pub. No.: US 2009/0242621 A1
(43) Pub. Date: Oct. 1, 2009

(54) DELIVERY SYSTEM

(76) Inventors: Masayuki MATSUSHITA, Arida-gun (JP); Yuki Tsuji, Wakayama-shi (JP)

Correspondence Address: FULBRIGHT & JAWORSKI, LLP, 666 FIFTH AVE, NEW YORK, NY, 10103-3198, US

(21) Appl. No.: 12/410,853

(22) Filed: Mar. 25, 2009

(30) Foreign Application Priority Data
Mar. 26, 2008 (JP) 2008-081492

(51) Int. Cl. G06F 17/00

(52) U.S. Cl. 235/375

(57) ABSTRACT

A delivery system includes a receiving device for receiving an order from a customer, a plurality of delivering devices each of which includes a storage unit having a plurality of storage spaces for storing therein recording media according to the unit of customer's order and a delivering controlling unit operable to obtain ID information associated with the recording medium, thereby realizing delivery of the recording medium associated with the ID information, a storage managing device for setting the delivering device storing the recording medium of the order received by the receiving device and a reception slip producing device for obtaining, from the storage managing device, specifying information of the delivering device which stores the recording medium of said order and producing a reception slip recording the specifying information and the ID information therein.

### BACKGROUND OF THE INVENTION

1. Field of the Invention

The present invention relates to a delivery system including a delivering device, the delivering device having a storage unit with a plurality of storage spaces for storing therein recording media according to the unit of customer's order and a delivering controlling unit operable to obtain ID information associated with the recording medium, thereby realizing delivery of the recording medium associated with the ID information. The invention relates more particularly to a delivery system for delivering such recording medium as an image-printed print paper to a customer.

2. Description of the Related Art

Constructions relating to the delivery system having the above-described construction are known from e.g. Japanese Patent Application “Kokai” No. 9-15827 and Japanese Patent Application “Kokai” No. 2003-157474. The Japanese Patent Application “Kokai” No. 9-15827 discloses an automated photographic laboratory processing system which includes a processor section for effecting printing process from a photographic film to a print paper, a shipping section for packing DPE products in a bag and returning them to a customer, and a central control section for effecting centralized control of the DPE products based on ID attached to a photographic film.

According to this construction of Japanese Patent Application “Kokai” No. 9-15827, when the system receives an order for printing from a negative film and receiving monetary charge payment therefor, the system will prepare a card that records, in its data recording area 46, the ID together with other information such as the date of order receipt and the expected date of delivery and give this card to the customer. After this order reception, printing exposure from the negative film to the print paper and then development of the printed paper are carried out. Thereafter, the negative film sheet and the prints will be packed together in a bag and dropped from a hopper section onto a table provided in a conveyer type stock section.

Also, a shipping unit controller correlates an address provided to this table with the ID provided to the bag. The conveyor type stock section includes a plurality of such tables, each of which is configured rotatable about a right/left axis. In operation, as the table is rotated about this axis, the DP bag placed thereon can be slid down to be fed. Next, when the customer inserts the card to the system and requests return, based on the ID provided in the card, the shipping controller unit searches the address from the ID and brings a table corresponding to the address into registry with a return opening and then rotates the table about the axis for slidably guiding and dropping the DP bag thereon, so that the bag can be taken out from the return opening.

In the case of the Japanese Patent Application No. 2003-157474, there is provided an automated print receiving/delivering apparatus including an automated receiving section and an automated delivering section, the apparatus being installed to e.g. an outer wall face of a shop. In operation, a customer inputs information of the order and information for identifying this customer per se and charges a film or a recording medium used in a digital camera or the like to a film receiving section. Then, the system prints out an order card in the form of a magnetic card printed with the order information, etc.

Next, printing operation from the film will be effected in e.g. a DPE shop and printed product (corresponding to a “recording medium” of the invention) will be put in a storage bag (corresponding to a “package” of the invention) and stored under this condition in a storage room. This storage room has a door which can be locked. Then, when the customer is to receive the printed product, he/she will insert the order cad into an order information confirming section and pay an amount of charge shown on a monitor to a charge receiving section. In response to this, the display will show a number of storage chamber corresponding to the order and the door of the storage chamber will be unlocked. So that, the customer can now open the door and take out the printed product.

In the case of small-sized DPE shops, the above techniques disclosed in the Japanese Patent Application “Kokai” No. 9-15827 and the Japanese Patent Application “Kokai” No. 2003-157474 will be useful for efficient operation with such limited number of shop attendants, since the techniques allow the process of delivering prints to the customer who ordered them to proceed in an unmanned manner, i.e. without any intervention by any shop attendant.

And, if a great amount or number of printed products are to be delivered to customers, it will be effective to install a plurality of the apparatuses (delivering apparatuses) disclosed in the Japanese Patent Application “Kokai” No. 9-15827 or the Japanese Patent Application “Kokai” No. 2003-157474. Further, in case a plurality of delivering devices are employed, it may be desired to limit the kind of recording medium to be stored in each delivering device in order to achieve efficient storage. More particularly, when it is desired to store a relative small sized printed product commonly referred to as “service size” and a larger-sized printed product in a same device, it becomes needed to adapt the storing space to the larger-sized printed product, thus requiring enlargement of the storing space. This results in enlargement of the entire device and reduction in the storage capacity or storable number of products.

In view of the above, it is presently conceived to provide a delivering device adapted for storing the relatively small-sized printed products and a delivering device adapted for storing the larger-sized printed products, separately.

However, in case a plurality of delivering devices for delivering printed product to customers are provided, when a customer receives a printed product, the customer may not be able to judge from which delivering device the product can be received.

As such, there is a need for constructing an improved system in a rational manner which system allows easy judgment from which delivering device the target recording medium can be received.

### SUMMARY OF THE INVENTION

According to a characterizing feature of the present invention, in a delivery system with a delivering device including a storage unit having a plurality of storage spaces for storing therein recording media according to the unit of customer's order and a delivering controlling unit operable to obtain ID information associated with the recording medium, thereby realizing delivery of the recording medium associated with the ID information, the system comprises:

a plurality of said delivering devices;

a receiving device for receiving an order from a customer;

storage managing means for setting the delivering device storing the recording medium of the order received by said receiving device; and

reception slip producing means for obtaining, from said storage managing means, specifying information of the delivering device which stores the recording medium of said order and producing a reception slip recording said specifying information and said ID information therein.

With the above construction, when a customer has placed an order for processing of image data at the receiving device, specifying information for specifying a delivering device is obtained from the storage managing means and the reception slip producing means records this specifying information and the ID information in a reception slip. Therefore, even if a plurality of delivering devices are installed, a customer can readily find from which delivering device the reception of the recording medium is possible. Hence, there has been achieved an improved rational system which allows reception of recording medium without waste of time. In particular, in case a plurality of kinds of recording media are stored in different delivering devices as it happens when a plurality of kinds of recording media have been ordered, it is possible to prevent the customer from forgetting to receive them, since the reception slip records the specifying information of the plurality of kinds of delivering devices from which the recording media are to be received.

According to a modified construction of the present invention, the storage managing means sets other delivering device to store the recording medium of the order, based upon storage condition of recording media in the plurality of storage units of the delivering device and progress condition of the orders already received. With this construction, based upon storage condition of recording media and progress condition of the orders, a device (s) capable of storing can be searched and a device to storing the recording medium of the order can be set.

According to a further modified construction of the present invention, said delivering device includes a case having the storage unit therein, a feeding unit for feeding the recording medium stored in the storage unit to the outside of the case, and ID information obtaining means for obtaining the ID information; and said delivering controlling unit determines the storing space where the recording medium associated with the ID information is stored and controls said feeding unit to feed the recording medium from the storing space. With this construction, when the recording medium associated with the ID information is stored, only by the customer's inputting the ID information to the ID information obtaining section, the recording medium associated with this ID information will be fed by the feeding unit from the storage unit in the case, so that the customer can receive this recording medium.

According to a still further modified construction of the present invention, the system further comprises a printing unit for printing image information on the recording medium and an automatic charging unit for charging the recording medium printed at the printing unit to the storage unit. With this construction, it is possible to eliminate the need for e.g. a DPE shop attendant to store the recording medium at a storing space in the storage unit.

Further and other features and advantages of the present invention will become apparent upon reading the detailed disclosure of some presently preferred embodiments thereof with reference to the accompanying drawings.

### BRIEF DESCRIPTION OF THE DRAWINGS

FIG. 1 a perspective view showing an entire construction of a delivery system,

FIG. 2 a perspective view of a receiving device,

FIG. 3 a vertical section showing an inkjet printer, an enveloper and a delivering device,

FIG. 4 a perspective view showing the general construction of the delivering device,

FIG. 5 a view showing an upper portion of the front face of the delivering device,

FIG. 6 a block circuit diagram showing the controlling construction of the delivery system,

FIG. 7 a diagram showing flows of information in the controlling construction,

FIG. 8 a flowchart showing sequence of a delivery process, and

FIG. 9 a view showing a reception slip.

### DETAILED DESCRIPTION OF THE PREFERRED EMBODIMENTS

Next, an embodiment of the present invention will be described with reference to the accompanying drawings.

### [General Construction]

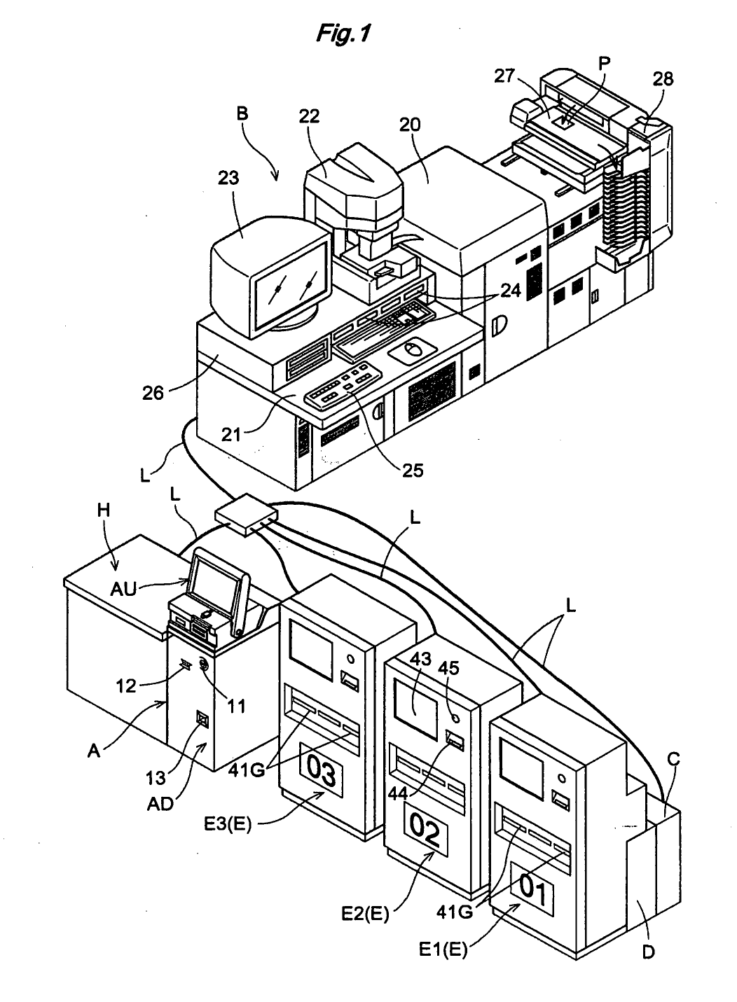

As shown in FIG. 1, a delivery system comprises a receiving device A, a silver halide photographic printer B for printing image data on a recording medium P which is a silver halide print paper, based on information from the receiving device A, and three delivering devices E.

The delivering devices E comprises a first delivering device E1, a second delivering device E2 and a third delivering device E3. These three delivering devices E respectively store a recording medium P which corresponds to the size or the type (such as glazed paper, semi-glazed paper) of recording medium to be used in the printing. Further, on the front face of each one of the three delivering devices E, there is displayed a numeral for specifying each device E,

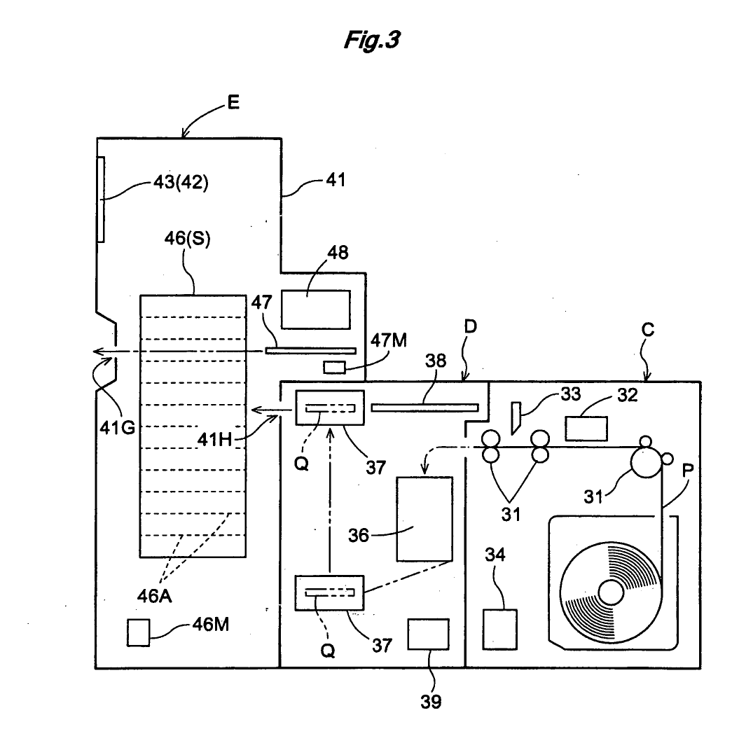

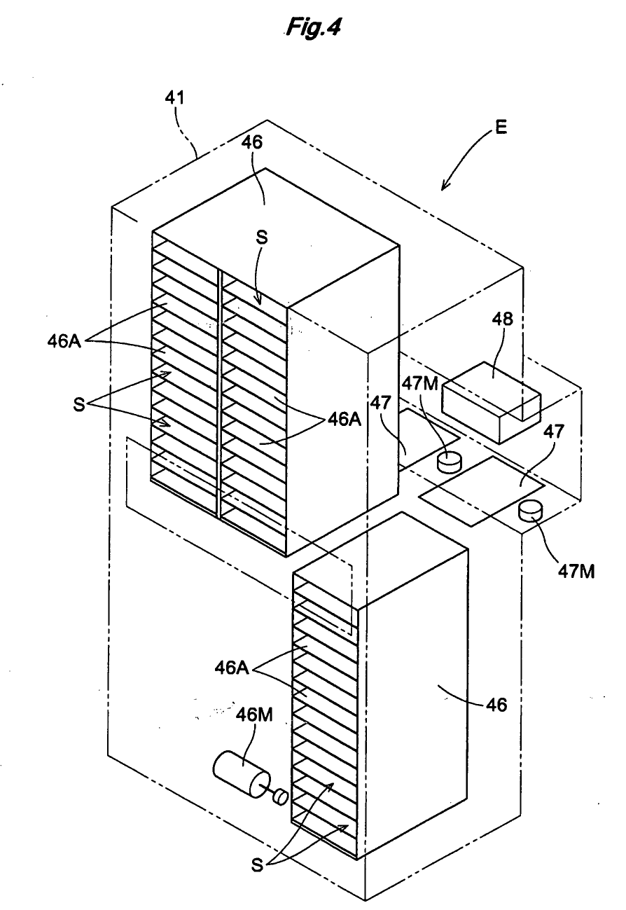

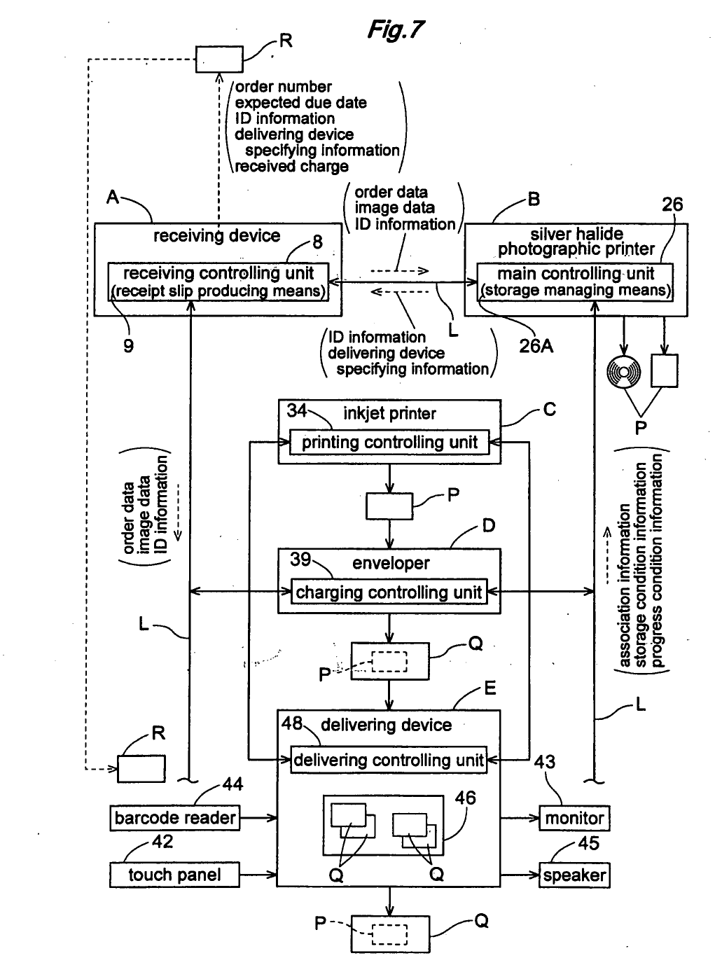

In particular, a recording medium P printed by the silver halide photographic printer B is manually charged into a processing bag Q (see FIG. 7). After this charging, this processing bag Q is manually stored in a storage unit 46 (see FIG. 3 and FIG. 4) of the third delivering device E3. In this manner, the third delivering device E3 is to store recording media P which cannot be automatically printed or which are less frequently printed, such as a postcard, a greeting card, etc.

The first delivering device E1 and the second delivering device E2 each includes an inkjet printer C for printing image data on a recording medium P comprised of a print paper and an enveloper D for charging the printed recording medium P into the processing bag Q. This enveloper D automatically charges a recording medium P as contained in the processing bag Q to a storage unit 46 of the corresponding delivering device E. These two kinds of delivering devices E are installed for storing recording media of different sizes/or types and are used for storing prints of frequently printed type, commonly known as the “service size” prints.

This delivery system is assumed to be installed in a relatively large-scaled DPE photo service shop or a large-scaled electric appliance shop, etc. In such DPE shop or the like, the system is provided with a counter table H which allows receiving of a photographic film and receiving and processing of a customer's order associated therewith.

This delivery system realizes control operations for delivering finished recording medium P to a customer e.g. after the DPE shop is closed or in a situation without any shop attendant. To realize such control operations, the delivering device E will be installed at such a position as an outer wall surface of the shop or a position facing a corridor. Further, this delivery system is configured to automatically effect the operation of printing image on a recording medium P of a predetermined size, the operation of charging the processed recording medium P into a processing bag Q and the operation of charging the processing bag Q containing the recording medium P to the delivering device E. With this, the present delivery system realizes reduction in the amount of work of the DPE shop attendant.

As shown in FIG. 1 and FIG. 6, these devices, namely, the receiving device A, the silver halide photographic printer B, the inkjet printer C, the enveloper D, and the delivering devices E are connected via a communication cable L to allow information access relative to each other. Incidentally, the communication cable L is assumed to be one effecting communication by a wired LAN technique. However, this cable may use any other technique such as intranet technique, wireless communication technique, etc.

### [Brief Overview of Processing]

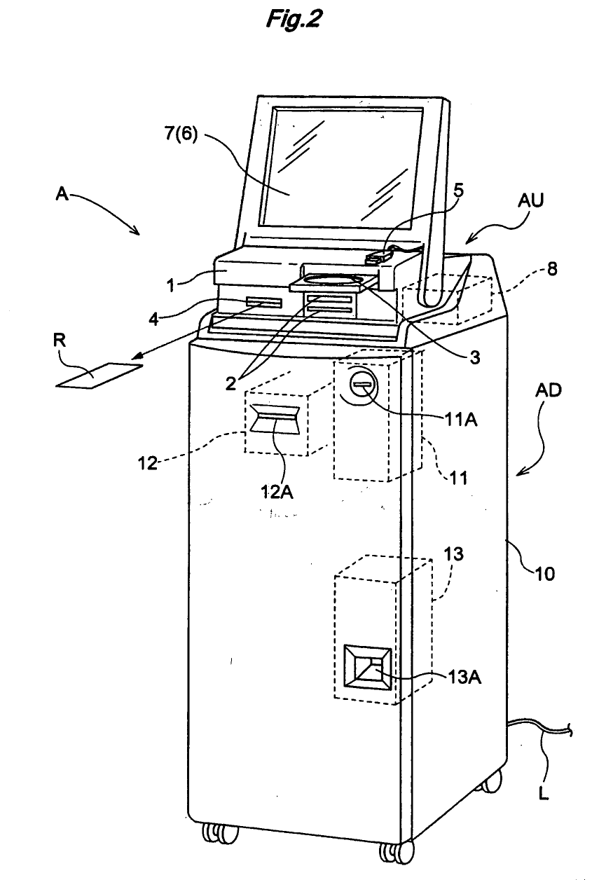

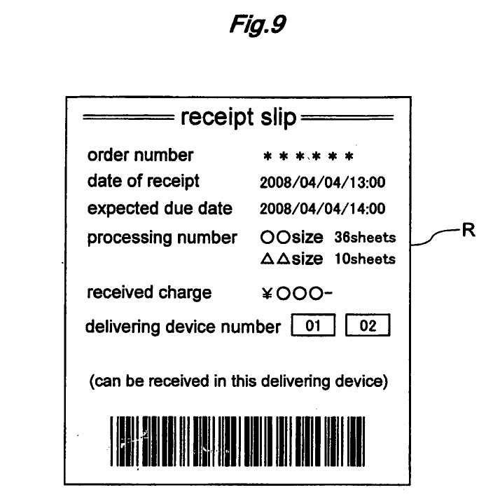

When the receiving device A has received an order for printing processing from a customer, this receiving device A obtains image data, receives payment for a charge corresponding to the order and prints out a receipt slip R (see FIG. 2 and FIG. 9) on which ID information and specifying information specifying a delivering device E which has stored the recording medium P are printed.

This specifying information is comprised of a numeral shown on the front face of the delivering device E. Alternatively, each delivering device E may be painted with a different design or color and a similar paining may be provided on the receipt slip R.

If the print size specified by the order received at the receiving device A is a relatively small size referred to as “service size”, then, the image data received by the receiving device A is transmitted to the inkjet printer C and printed on the recording media P which are print papers. The printed recording media P are put into the processing bag Q at the enveloper D and the enveloper D charges this processing bag Q into a storage unit 46 of the delivering device E (the first delivering device E1 or the second delivering device E2).

Or, if the print size specified by the order received at the receiving device A differs from the predetermined service size or is a size which is not frequently printed or the image date is to be recorded in a recording medium P comprised of a CD-R to be made into an electronic photo album, the image data received at the receiving device A is transmitted to the silver halide photographic printer B. The transmitted image data will then be printed on silver halide type recording media P by an operator or recorded in a CD-R to be manually put into the processing bag Q according to the customer's order. The recording media P comprised of printed image data or recording medium P comprised of a CD-R recording the image data therein will be manually charged to the third delivering device E3 by a DPE shop attendant.

After the storage of the processing bag Q at the delivering device E, if the customer is to receive the recording medium P, the customer causes a barcode reader 44 provided in the delivering device E to read the ID information in the receipt slip R. With this, the processing bag Q containing the recording medium P associated with the ID information will be automatically fed from the delivering device E, so that the customer can receive the processing bag Q thus fed.

Incidentally, if an order received at the receiving device A from a customer contains the service size and a non-service size(s) in a mixed state, then, the recording media P will be stored at two delivering devices separately, so two delivering processes will be carried out simultaneously and the customer will receive the recording media P from two delivering devices E.

### [Receiving Device]

As shown in FIG. 2, the receiving device A consists of an upper receiving terminal AU and a lower charge receiving terminal AD. The receiving terminal AU includes, in a front face of a main body 1 thereof, a plurality of kinds of semiconductor drives 2 for obtaining photographic data from various semiconductor type memories (not shown) such as a “compact flash” (trademark) card, an SD card (trademark), a memory stick (trademark), a disc drive 3 for obtaining photographic data from various kinds of disc type media (not shown) such as a floppy disc (trademark), an MO, a CD-R, a receipt slip printer 4 for printing and discharging the receipt slip R and includes, in the upper face of the main body 1, a connector 5 to be connected to a mobile phone with a camera for obtaining photographic data therefrom, and a liquid-crystal type monitor 7 forming a touch panel 6 on its displaying face for displaying necessary data. Further, the receiving device A includes, inside its main body 1, a receiving controlling unit 8 for processing received information and transmitting the processed information via a communication cable.

The charge receiving terminal AD incorporates therein a coin receiving unit 11 for receiving a coin(s) from a coin inserting slot 11A provided at an upper position of a vertically elongated case 10 and a bill receiving unit 12 for receiving a bill(s) from a bill inserting slot 12A. At a lower position of the case 10, there is provided a small change discharging unit 13 for discharging small change(s) from a small change discharging outlet 13A.

With this receiving device A, in the receiving terminal AU, under a condition of a customer setting a medium to the semiconductor drive 2 or the disc drive 3 or the customer connecting a mobile phone to the connector 5, the customer touches his/her finger on the touch panel 6 in accordance with guidance displayed on the monitor 7, so that the receiving device A obtains the image data from the medium or the mobile phone and obtains also order data for e.g. a print processing.

With this system, the sequence of the receiving process is configured such that after obtaining an order, the order is completed upon the customer's payment of a charge required for the processing at the charge receiving terminal AD.

### [Silver Halide Photographic Printer]

The silver halide photographic printer B, as shown in FIG. 1, includes a housing 20 having a dark box construction. On the top surface of a console 21 provided at an end of this housing 20, there are mounted such devices as a film scanner 22, a monitor 23 for displaying information, a disc drive 24, a keyboard 25, etc. And, there is also provided a main controlling unit 26 for effecting process required for printing.

Further, the housing 20 accommodates therein, though not shown, an exposing section for effecting exposure on a recording medium P comprised of a print paper, a developing section for effecting development of the exposed recording medium, and a drying section for effecting drying of the developed recording medium. Outside the housing 20, there are provided a conveying belt 27 which receives the recording medium P after its drying, and a sorter 28 for sorting recording media conveyed from the conveying belt 27 according to the unit of each customer's order.

This sliver halide photographic printer B effects a printing operation by an operator or production of an electronic album using e.g. CD-R, based on the image data and the order data transmitted from the receiving device A.

### [Inkjet Printer]

As shown in FIG. 4, in the inkjet printer C, there is formed a conveying passageway along which a plurality of clamping rollers 31 are arranged for conveying the recording medium P comprised of en elongate recording paper wound in the form of a roll. A print head 32 is provided for discharging ink onto the recording medium P conveyed along this conveying passageway along a sub scanning direction while the head 32 is moving back and forth along a main scanning direction normal to the sub scanning direction. A cutter 33 is provided for cutting the recording medium P printed with the image data by the print head 23 into a print size(s). And, a printing controlling unit 34 is provided for controlling these components of the printer.

With this inkjet printer C in operation, based upon the image data and the order data transmitted from the receiving device A, the printing controlling unit 34 controls the clamping rollers 31, the print head 32 and the cutter 33, thereby to realize the printing processing of the image data on the recording medium P made of a print paper. In succession thereto, the recording medium A printed with the image data will be fed to the enveloper D which is described next.

### [Enveloper]

As shown in FIG. 3, the enveloper D includes a charging section 36 which operates to stack a plurality of recording media P printed at the inkjet printer C for their temporary stacked storage and charges the stored recording media P into the processing bags Q according to the unit of the customer's orders, a shift mechanism 37 which mounts thereon and elevates the processing bag Q charged with the recording medium P at the charging section 36 and then moving it horizontally to set it at an inserting position, a pusher 38 which pushes the processing bag Q mounted on the shift mechanism 37 at the inserting position into the delivering device E, and a charging controlling unit 39 for controlling these components. Incidentally, the shift mechanism 37 and the pusher 38 together constitute an “automated charging unit” used in the present invention.

In this enveloper D, the charging controlling unit 39 executes a series of control operations in which the recording media P fed therein one after another from the inkjet printer C are inserted into the processing bags Q of sizes predetermined according to the customer's order units and closing the bags for packaging the recording media and these bags are then inserted to respective storage spaces of the delivering device E which will be described later.

In the instant embodiment, the enveloper D is configured to charge the recording medium P into the processing bag Q. Alternatively, the developer D can be configured also to effect, as packaging operations, charging of the recording medium into a box-like container or wrapping the recording medium P with resin sheet for its packaging.

### [Delivering Device]

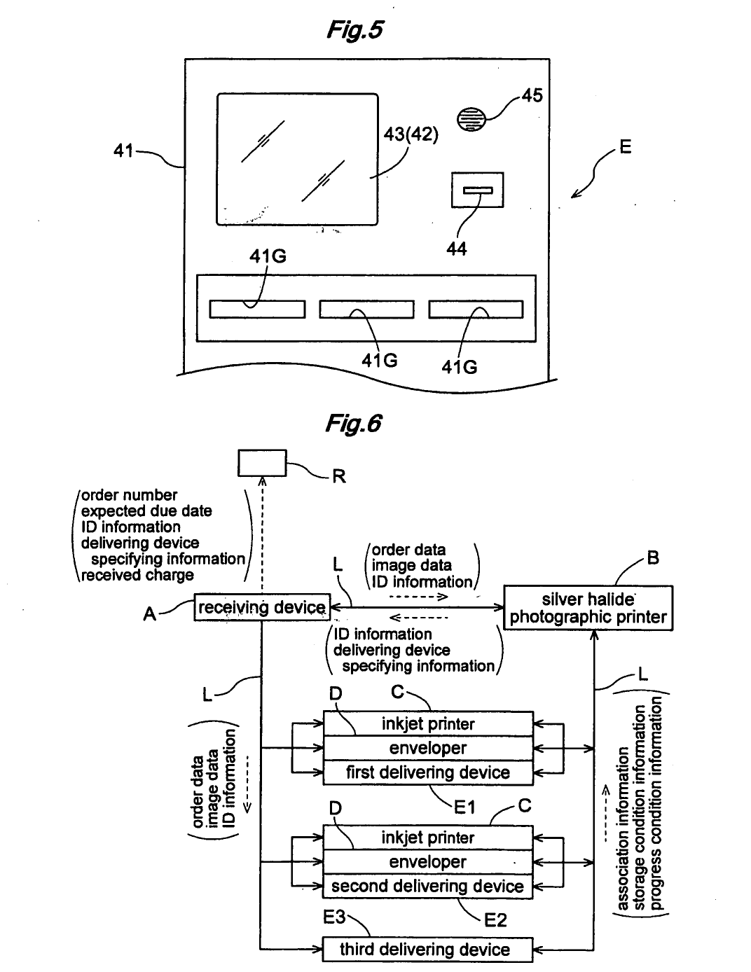

As shown in FIG. 3 through 5, the delivering device E includes a monitor 43 having a casing 41 with a touch panel 42 formed on its displaying front face thereof, a barcode reader 44 (an example of “ID information obtaining section”) for reading ID information from the receipt slip R, and a speaker 45. At the center of the casing 41, there are formed three openings 41G for allowing a customer to take out the recording medium P charged in the processing bag Q. In the rear face of the casing 41, there is formed an inlet opening 41H for receiving the processing bag Q sent from the enveloper D.

Inside this casing 41, there are mounted two storage units 46 which are movable up/down, and an electrically driven type elevating motor 46M for lifting up/down the respective storage units 46. In the rear section of this casing 41, there are provided three feeding plates 47 (an example of “feeding unit”) for feeding the processing bags Q stored in the storing spaces S of the storage units 46 through an opening 41G, and an electrically driven motor 47M for projecting/retracting these three feeding plates 47. Also inside this casing 41, there is provided a delivering controlling unit 48 for controlling these components.

Each storage unit 46 is constructed as a rack including a plurality of supporting plates 46A for partitioning the inner space of the storage unit into a plurality of storing spaces S (storing compartments). Further, the two storage units 46 are disposed side by side on the right and left, with one having two columns of support plates 46A, the other having one column of support plates 46A, respectively.

These two storage units 46, as receiving drive force from the elevating motor 46M via a chain, are lifted up/down along guide rails (not shown). Further, a driving arrangement is provided in this lifting up/down such that the storage units 46 are lifted in opposite directions from each other so as to achieve good weight balance therebetween.

As the lifted position of the storage unit 46 is obtained by means of a sensor (not shown), it is made possible to obtain the positional relationship between each storing space S and the opening 41G as well as the positional relationship between each storing space S and the inlet opening 41H. Further, the position of the recording medium P (the position of the processing bag Q) stored in the storing space S is managed by the delivering controlling unit 48.

With the above-described construction in operation, when a recording medium P charged in a processing bag Q is to be received from the enveloper D, the delivering controlling unit 48 lifts up/down the storage unit 46 so as to move an empty storage space S not storing any processing bag Q therein to the position of the inlet opening 41H. Similarly, when a recording medium P charged in a processing bag Q is to be fed from the delivering device E, the storing unit 46 is lifted up/down to be moved the storing space S storing therein the processing bag Q to be fed to the position of the opening 41G.

And, when a customer is to receive the recording medium P, the barcode reader 44 of the delivering device E reads the ID information on the reception slip R. Then, the delivering controlling unit 48 will identify and specify the storing space S which stores the particular recording medium P associated with the ID information and will then lift up/down the storage unit 46 of a delivering device corresponding to this specified storing space S and operate the feeding plate 47 to feed the recording medium P charged in the processing bag Q from the opening 41G. With this, the customer can receive the recording medium P charged in the processing bag Q.

### [Controlling Construction of the System]

As shown in FIG. 6 and FIG. 7, there is provided a signal line for transmitting information from the receiving controlling unit 8 of the receiving device A to the main controlling unit 26 of the silver halide photographic printer B via a communication cable L. Further, there is provided a signal line for transmitting information from the receiving controlling unit 8 to the printing controlling unit 34 of the inkjet printer C, the charging controlling unit 39 of the enveloper D, and to the delivering controlling unit 48 of the receiving device A via the communication cable L. The main controlling unit 26 functions to manage the entire delivery system of the present invention. A signal line is provided to allow access of information to this main controlling unit 26, from the printing controlling unit 34, the charging controlling unit 39 and the delivering controlling unit 48.

The receiving controlling unit 8, the main controlling unit 26, the printing controlling unit 34, the charging controlling unit 39, and the delivering controlling unit 48 respectively include a microprocessor and software for realizing the process corresponding thereto.

The main controlling unit 26, in each delivering device E, obtains via the signal line association information which associates the recording medium P and the storing space S storing this recording medium P. As will be described next, the main controlling unit 26 obtains also, as progress information, information on a reducing medium P under printing after order receipt, information on the storing space S to store the recording medium P where no recording medium P is stored yet in the delivering device E.

### [Procedure of Delivering Operation]

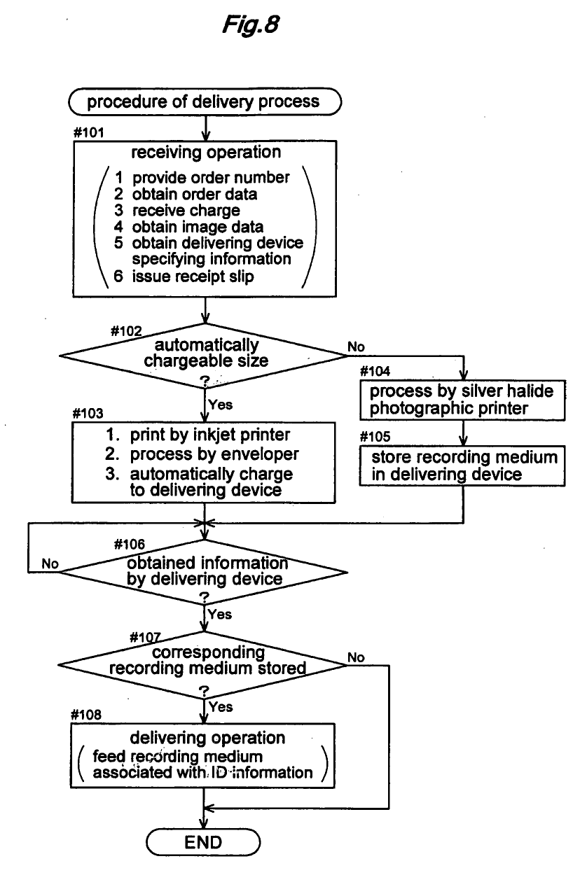

FIG. 8 shows a flowchart which illustrates the general flow of the procedure comprising making of recording medium P and delivery of this recording medium P to a customer, with use of the system construction shown in FIG. 6 and FIG. 7.

That is to say, the reception process is executed by a customer's setting of a medium recording image data therein to the receiving terminal AU of the receiving device A and then placing an order thereto (step #101).

More particularly, when the customer initiates the ordering process by touching, with e.g. his/her finger, an icon(s) displayed on the monitor 7 at the receiving device A, the receiving controlling unit 8 provides an order number and obtains order data relating to the required print size, the required number of prints, etc. for the printing processing.

Next, upon the above-described order setting, the receiving controlling unit 8 causes the monitor 7 to display the charge for the requested processing. In response, the customer will make the payment for the charge by putting a bill(s) and/or a coin(s) to the coin inserting slot 11A and/or the bill inserting slot 12A. Then, the receiving unit 8 obtains the image data to be processed and delivering device specifying information which specifies a delivering device to store the recording medium P.

In obtaining the delivering device specifying information, the reception slip producing means 9 of the receiving controlling unit 8 of the receiving device A requests the delivering device specifying information to the storage managing means 26A of the main controlling unit 26. To this request, the storage managing means 26A obtains information on storage condition of the recording media P currently stored in the storage unit 46 of each delivering device E and obtains also, from the delivering controlling unit 48, information on progress condition of a printing process currently being effected.

After obtaining the delivering device specifying information, the receiving device A specifies a delivering device E which is to store the recording medium P of the currently received order and sets specifying information. Then, the receipt slip producing means 9 produces (prints), on a receipt slip R, the order number, the expected due date of delivery, the contents of the order, the received charge, the delivering device specifying information specifying the delivering device E, ID information comprised of a barcode, etc. FIG. 9 shows an example of the receipt slip R produced in this manner. As shown in this figure, on the receipt slip R, there are printed numbers which specify the delivering devices E. Instead, as the specifying information, a geographical image of the position(s) of the delivering device(s) may be printed.

Then, if the receiving controlling unit 8 determines based on the order data obtained as above that the requested print size(s) is (are) size(s) which can be automatically loaded from the enveloper D to the delivering device E, then, based upon the order data, the first delivering device E1 or the second delivering device E2 will be selected as a storage destination based upon the print size(s) and the type of recording paper.

Then, a printing processing based on the order data is effected at the inkjet printer C connected to the selected delivering device E. Subsequent to this printing processing, the enveloper D will charge the printed recording medium P into a processing bag Q according to the customer's order unit and also charges this processing bag Q to that delivering device E (step #102, step #103).

Especially, at step #102, if it is found that the size of one print size included in the plurality of prints in the order is a size which allows automatic charging from the enveloper D to the delivering device E and the other print size in the order is a size which does not allow the automatic charging from the enveloper D to the delivering device E (including the case where an electric photo album is to be made in a recording medium P comprising a CD-R disc), the receiving controlling unit 8 will transmit the image data and the order data to both the inkjet printer C and the silver halide photographic printer B.

In the course of the above-described series of processing, in the inkjet printer C, the printing controlling unit 34 receives the image data and the order data from the receiving controlling unit 8. Further, this printing controlling unit 34 controls the respective components of the inkjet printer C based on the order data, thereby to print the image data on the recording media P formed of print papers.

Further, in the enveloper D, the charging controlling unit 39 determines the number of prints included in the order by receiving the information from the printing controlling unit 34 and effects an operation of charging the number of prints of the recording media P corresponding to that order into a processing bag Q. When the processing bag Q is to be charged to the delivering device E, the charging controlling unit 39 obtains the position information of the storing space S from the delivering controlling unit 48 and moves the shift mechanism 37 to an inlet opening 41H corresponding thereto.

In operative association with the above, the delivering controlling unit 48 of the delivering device E controls the elevating motor 46M to move the processing bag Q to the position of the inlet opening 41H of the storing space S where it is to be stored. Information on completion of this movement will be transmitted to the charging controlling unit 39, so this charging controlling unit 39 will activate the pusher 38 to charge the processing bag Q into the storing space S.

When the processing bag Q has been charged into the storing space S in the manner above, association information which associates the ID information of this recording medium P charged in the processing bag Q and the position information of the storing space S is stored in the delivery controlling unit 48 and at the same time, this association information is transmitted to the main controlling unit 26 to be stored therein. Incidentally, with this storage of the association information, the main controlling unit 26 can grasp the “whereabouts” of the recording medium P to be managed by the ID information and the silver halide photographic printer B can grasp presence/absence of delivery.

Moreover, if it is found, based upon the order data obtained at the receiving device A, the print size is not a size which allows automatic charging from the enveloper D to the delivering device E (including the case of making an electronic photo album in a recording medium P comprised of a CD-R disc), the sliver halide photographic printer B will carry out printing of the image data on the recording media comprised of print papers. Or, the image data will be recorded in the recording medium P comprised of a CD-R disc to make an electronic photo album (steps #102, #104).

Upon completion of the processing at the silver halide photographic printer B described above, an attendant of the DPE shop will carry out a manual operation of putting the recording media P into a storing space S provided in the third delivering device E3 (step #105).

Upon completion of the above storage, the association information that associates the ID information of the recording media P with the position information of the storing space S will be transmitted to the delivering controlling unit 48 to be stored therein and stored also in the main printing controlling unit 26. Incidentally, with the storage of this association information therein, the main controlling unit 26 can specify/identify the delivering device E where the recording medium P managed by the ID information is stored and the silver halide photographic printer B can grasp the presence/absence of delivery.

Next, when the customer is to receive the recording medium P from the delivering device E, the customer causes the barcode reader 44 of the delivering device E specified by the specifying information printed on the receipt slip R to read the ID information of the reception slip R. Then, the recording medium P associated with the ID information is specified and the storing space S storing this recording medium P is specified. Next, the feeding plate 47 (an example of “feeding unit”) is operated to be projected, whereby the processing bag Q containing the recording medium P associated with the ID information can be fed out of the opening 41G, and the customer can receive it (steps #106 through #108).

### Other Embodiments

(a) In the present invention, the delivering device E does not need to include any feeding unit. That is to say, as described also in the Japanese Patent Application “Kokai” No. 2003-157474, the system can be constructed such that when the ID information has been inputted, the recording medium P can be taken out manually from the storing space storing the recording medium corresponding to that ID information.

(b) The receipt slip R may record the ID information in the form of magnetic data. Even if the receipt slip R is constructed as this, the specifying information for specifying the delivering device(s) E will be printed in the form of character information or icon for allowing the customer's recognition.

(c) The storage managing means may be included in the receiving device A or may be provided as an independent device. In the case of using such independently provided device, it is not needed for this device to act also as the main controlling unit 26 of the silver halide photographic printer B as in the foregoing embodiment.

### Effect of Embodiment

With the above-described constructions, when a customer is to receive the recording medium P, the customer causes the barcode reader 44 of the delivering device E specified by the specifying information recorded in the receipt slip R to read the ID information in the receipt slip R, so that the customer can receive the recording medium P from this delivering device E speedily.

Also, this system automatically effects the operations that for a fixed size such as the service size which is frequently printed, image data is printed on the recording medium P with using an inkjet printer C corresponding to the first delivering device E1, the second delivering device E2 of the three delivering devices E and this recording medium P is charged by the enveloper C according to the customer's order unit into the processing bag Q and then charging this processing bag Q to the corresponding delivering device E (the first delivering device E1 or the second delivering device E2). This enables reduction in the number of attendants.

1. A delivery system comprising:
a receiving device for receiving an order from a customer;
a plurality of delivering devices each of which includes a storage unit having a plurality of storage spaces for storing therein recording media according to the unit of customer's order and a delivering controlling unit operable to obtain ID information associated with a recording medium, thereby realizing delivery of the recording medium associated with the ID information;
storage managing means for setting a delivering device storing the recording medium of the order received by said receiving device; and
reception slip producing means for obtaining, from said storage managing means, specifying information of the delivering device which stores the recording medium of said order and producing a reception slip recording said specifying information and said ID information therein.

2. The delivery system according to claim 1, wherein said storage managing means sets the delivering device to store the recording medium of the order, based on storage condition of the recording media in the plurality of storage units of the delivering device and progress condition of the orders already received.

3. The delivery system according to claim 1, wherein each delivering device includes a case having the storage unit therein, a feeding unit for feeding the recording medium stored in the storage unit to the outside of the case, and ID information obtaining means for obtaining the ID information; and
wherein said delivering controlling unit determines a respective storing space of the respective storage unit where the recording medium associated with the ID information is stored and controls said feeding unit associated with said respective storage unit to feed the recording medium from the storing space.

4. The delivery system according to claim 1, further comprising a printing unit for printing image information on the recording medium and an automatic charging unit for charging the recording medium printed at the printing unit to the storage unit.
